(19) United States
(12) Patent Application Publication
(10) Pub. No.: US 2021/0106927 A1
(43) Pub. Date: Apr. 15, 2021

(54) SYSTEM AND METHOD FOR TREATING CHEMICAL BYPRODUCTS USING ULTRASONIC IRRADIATION

(71) Applicants: Hossein Vojoudi, Ardebil (IR); Alireza Badiei, Tehran (IR); Elham Vojoudi, Ardebil (IR)

(72) Inventors: Hossein Vojoudi, Ardebil (IR); Alireza Badiei, Tehran (IR); Elham Vojoudi, Ardebil (IR)

(21) Appl. No.: 16/600,459

(22) Filed: Oct. 12, 2019

(51) Int. Cl. B01D 15/38; B01D 15/22; B01D 15/16

(52) U.S. Cl. CPC B01D 15/3866; B01D 15/161; B01D 15/22; B01D 15/3871

(57) ABSTRACT

A system and a method for treating chemical byproducts within an analyte solution are disclosed. The system comprises a container for storing the analyte solution, a cartridge with one or more columns, a light source, an ultrasonic source, and a control system. The cartridge and the columns are fluidly connected to the container via a circulating line using a pump. The cartridge and the columns include adsorbent and absorbent materials, porous adsorbents, and nano-porous adsorbents to effectively adsorb and absorb the chemical byproducts such as metal ions, the organic compounds, and the inorganic compounds presented within the analyte solution. The light source is configured to transmit light signals into the cartridge and the columns and the ultrasonic source is configured to send ultrasound waves, thereby increasing the rate of adsorption and absorption of the chemical byproducts such as metal ions, organic compounds, and inorganic compounds within the analyte solution.

### BACKGROUND OF THE INVENTION

Environmental pollution is one of the most serious global challenges. Due to urbanization, rapid growth of industries, human and agricultural activities have had a significant impact on the environment pollution and also harmful. Technological solutions for controlling environmental pollution in different ways using various methods of operations is one of the most unsolved problems. Environment pollution due to the accumulation of soil and water from persistent toxic compounds such as, but not limited to, chemicals, salts, heavy metals, and radioactive substances cause adverse effects on both animals and humans.

Industrial plants generate polluting substances that are subject to strict rules in relation to their release to the environment. To this end, industrial plants are provided with different systems and special devices for the disposal/treatment thereof. However, the prior systems and devices do not efficiently extract the chemical compounds such as organic compounds and inorganic compounds that could be used in researches. In addition, different methods have been employed for the removal of these compounds from an aqueous solution, which some of these methods are pretty used in industries. In the past few decades, solid-phase extraction (SPE), spectrometry techniques, and atomic absorption spectrometry have been used for the isolation and purification of different aqueous samples and solutions.

The solid-phase extraction (SPE) is a sample preparation process by which compounds that are dissolved or suspended in a liquid mixture are separated from other compounds in the mixture according to their physical and chemical properties. Analytical laboratories use solid-phase extraction to concentrate and purify samples for analysis. Solid-phase extraction can be used to isolate analytes of interest from a wide variety of matrices, including urine, blood, water, beverages, soil, and animal tissue. In this method, a compound or a group of similar compounds with physical and chemical mechanisms or both with solid phase are inhibiting. Also, the inhibition process must be reversible so that inhibition species easily washed and solid phase be prepared for reuse. However, the conventional systems and methods are difficult to operate and are complex. The conventional systems and methods are not efficient for removal, extraction, and pre-concentration of metal ions, organic compounds, and inorganic compounds within the analyte solution. Further, the conventional systems and methods could not efficiently work in different environmental conditions.

However, the conventional systems and methods are difficult to operate and are complex. The conventional systems and methods are not efficient for removal, extraction, and pre-concentration of metal ions, organic compounds, and inorganic compounds within the analyte solution. Further, the conventional systems and methods could not efficiently work in different environmental conditions.

Therefore, there is a clear and present need for a system and method for treating any chemical byproducts such as, but not limited to, metal ions, organic compounds, and inorganic compounds within the analyte solution in different environmental conditions. Further, there is also a need for an inexpensive system and method for simply and efficiently treating any chemical byproducts within the analyte solution.

### SUMMARY OF THE INVENTION

The present invention generally relates to a system and method for simply and efficiently treating chemical byproducts and more particularly relates to a system and method for simply and efficiently treating chemical byproducts such as, but not limited to, metal ions, organic compounds, and inorganic compounds within the analyte solution using ultrasonic irradiation and a visible light in different environmental conditions.

In one embodiment, the system used for removal, extraction, and pre-concentration of metal ions, organic compounds, and inorganic compounds within an analyte solution is disclosed. In one embodiment, the system comprises a container, a cartridge with one or more columns, a light source, an ultrasonic source, and a control system. In one embodiment, the container is used for storing different analyte solutions. In one embodiment, the cartridge and the columns are fluidly connected to the container via a circulating line using a pump. The cartridge includes adsorbent materials and absorbent materials to adsorb and absorb the metal ions, the organic compounds, and the absorbed compounds presented within the analyte solution. In one embodiment, the columns could be, but not limited to, interchangeable columns. In one embodiment, the columns comprise at least any one of or a combination of, but not limited to, absorbents, porous adsorbents, and nano-porous adsorbents to adsorb and absorb the organic compounds and the inorganic compounds within the analyte solution. In one embodiment, the porous adsorbents and the nano-porous adsorbents are at least any one of or a combination of porous silica adsorbents, nano-porous polymer membranes, porous compounds, and nano-porous compounds to adsorb the organic compounds and the inorganic compounds within the analyte solution. In one embodiment, the nano-porous adsorbents/filters are interchangeable nano-porous membranes. In one embodiment, the columns of the cartridge further comprise nano-fiber membranes. The nano-fiber membranes are configured to securely hold the porous adsorbents and the nano-porous adsorbents within the columns of the cartridge.

The nano-fiber membranes comprise tiny holes or pores for securely holding the porous adsorbents and the nano-porous adsorbents within the one or more columns of the cartridge. The analyte solution could easily pass from inside the pores of the nano-porous membranes/shields. In one embodiment, the surface of the nano-fiber membranes within the columns could be modified by using organic compounds as adsorbents. In one embodiment, the nano-fiber membranes are prepared using, but not limited to, an electrospinning method. In one embodiment, the nano-fiber membranes could be, but not limited to, polymer nano-fiber membranes.

In one embodiment, the light source of the system is configured to transmit light signals into the cartridge and the columns for increasing the activity and rate of adsorption, thereby effectively removing, extracting, and pre-concentration of the metal ions, the organic compounds, and the inorganic compounds within the analyte solution. In one embodiment, the light source could be, but not limited to, visible ultraviolet light. The light source is used as a light-sensitive adsorbent level activator for effectively improving the rate of the adsorption. In one embodiment, the ultrasonic source is configured to send ultrasound waves into the cartridge and the columns for separating and desorption the metal ions, the organic compounds, and the absorbed compounds within the analyte solution. In one embodiment, the ultrasonic source could be at least any one of, but not limited to, an ultrasonic irradiation source, an ultrasonic transducer, and an ultrasonic sensor. In one embodiment, the ultrasonic source of the system further configured to the adsorption and the desorption of the metal ions, the organic compounds, and the inorganic compounds within the analyte solution.

In one embodiment, the system further comprises a control system. The control system in operatively communication with the system for controlling the adsorption and the desorption of the organic compounds and inorganic compounds within the analyte solution. In one embodiment, the control system is further configured to effectively control the flow rate of the analyte solution by controlling the operation of the pump. In one embodiment, the system further comprises a temperature control system with a heater. In one embodiment, the heater is securely and operatively connected to the container for controlling the temperature of the analyte solution, thereby achieving adjustable temperature conditions for effectively adsorption and absorption of the metal ions, the organic compounds, and the absorbed compounds presented within the analyte solution.

In one embodiment, a valve is connected within the circulating line for controlling the flow of the analyte solution. The valve is configured to allow and stop the flow of the analyte solution within the circulating line. In one embodiment, a sampler could be fluidly connected to the circulating line for analyzing the sample of the analyte solution.

In one embodiment, a flowchart for a method for treating chemical byproducts such as, but not limited to, metal ions, organic compounds, and inorganic compounds within the analyte solution using the system is disclosed. In one embodiment, the method was based on solid phase extraction technique. At one step, the analyte solution is distributed and transferred from the container to the cartridge and the columns by circulating the analyte solution via a circulating line using a pump of the system.

At another step, the ultrasound waves are sent into the cartridge and the columns using the ultrasonic source of the system for separating, adsorption, and desorption of the metal ions, the organic compounds, and the absorbed compounds presented within the analyte solution. Further, at step, the light signals are transmitted into the cartridge and the columns using the light source for increasing the activity and rate of adsorption, thereby effectively removing, extracting, and pre-concentration of the metal ions, the organic compounds, and the inorganic compounds within the analyte solution. In one embodiment, the light source could be, but not limited to, visible ultraviolet (UV) light.

One aspect of the present disclosure is directed to a system for treating chemical byproducts within an analyte solution, comprising: (a) a container for storing the analyte solution; (b) a cartridge with one or more columns, fluidly connected to the container via a circulating line using a pump, wherein the cartridge having adsorbent materials and absorbent materials to adsorb and absorb the metal ions, the organic compounds, and the absorbed compounds presented within the analyte solution; (c) an ultrasonic source configured to send ultrasound waves into the cartridge and the one or more columns for separating and desorption the metal ions, the organic compounds, and the absorbed compounds presented within the analyte solution, and (d) a light source configured to transmit light signals into the cartridge and the one or more columns for increasing the activity and rate of adsorption, thereby effectively removing, extracting, and pre-concentration of the metal ions, the organic compounds, and the inorganic compounds within the analyte solution.

In one embodiment, the one or more columns comprise at least any one of or a combination of absorbents, porous adsorbents, and nano-porous adsorbents for adsorption and absorption of the organic compounds and the inorganic compounds within the analyte solution, wherein the one or more columns are interchangeable columns. In another embodiment, the porous adsorbents and the nano-porous adsorbents are at least any one of or a combination of porous silica adsorbents, nano-porous polymer membranes, and porous and nano-porous compounds to adsorb the organic compounds and the inorganic compounds within the analyte solution. In one embodiment, the one or more columns of the cartridge further comprises nano-fiber membranes, wherein the nano-fiber membranes are configured to securely hold the porous adsorbents and the nano-porous adsorbents within the one or more columns of the cartridge.

In a related embodiment, the nano-fiber membranes comprises tiny holes or pores for securely holding the porous adsorbents and the nano-porous adsorbents within the one or more columns of the cartridge. In one embodiment, the nano-fiber membranes are prepared using an electrospinning method, wherein the nano-fiber membranes are polymer nano-fiber membranes. In one embodiment, the ultrasonic source is an ultrasonic irradiation source, wherein the ultrasonic source is further configured to control the adsorption and the desorption of the metal ions, the organic compounds, and the inorganic compounds within the analyte solution.

In one embodiment, the system further comprises a control system in operatively communication with the system for controlling the adsorption and the desorption of the organic compounds and the inorganic compounds within the analyte solution. In one embodiment, the system further comprises a temperature control system with a heater, securely and operatively connected to the container for controlling the temperature of the analyte solution, thereby achieving adjustable temperature conditions for effectively adsorption and absorption of the metal ions, the organic compounds, and the absorbed compounds presented within the analyte solution. In one embodiment, the light source is a visible ultraviolet light, wherein the light source is used as a light-sensitive adsorbent level activator for effectively improving the rate of the adsorption. In another embodiment, the pump is configured to continuously circulate the analyte solution within the system via the circulating line, thereby increasing the performance of the adsorbent material according to time and flow rate of the analyte solution, wherein the flow rate of the analyte solution is controlled via the control system.

Another aspect of the present disclosure is directed to a method for treating chemical byproducts within an analyte solution using a system, comprising the steps of: (a) distributing and transferring the analyte solution from a container to a cartridge and one or more columns of the system by circulating the analyte solution via a circulating line using a pump of the system, system comprising a container, a cartridge with one or more columns, an ultrasonic source, and a light source; (b) sending ultrasound waves into the cartridge and the one or more columns using the ultrasonic source of the system for separating, adsorption, and desorption of the metal ions, the organic compounds, and the absorbed compounds presented within the analyte solution, and (c) transmitting light signals into the cartridge and the one or more columns using the light source of the system for increasing the activity and rate of adsorption, thereby effectively removing, extracting, and pre-concentration of the metal ions, the organic compounds, and the inorganic compounds within the analyte solution, light source is a visible ultraviolet light.

In one embodiment, the one or more columns comprise at least any one of or a combination of absorbents, porous adsorbents, and nano-porous adsorbents for adsorption and absorption of the organic compounds and the inorganic compounds within the analyte solution, wherein the one or more columns are interchangeable columns. In another embodiment, the porous adsorbents and the nano-porous adsorbents are at least any one of or a combination of porous silica adsorbents, nano-porous polymer membranes, porous compounds, and nano-porous compounds to adsorb the organic compounds and the inorganic compounds within the analyte solution. In one embodiment, the one or more columns of the cartridge further comprises nano-fiber membranes, wherein the nano-fiber membranes are configured to securely hold the porous adsorbents and the nano-porous adsorbents within the one or more columns of the cartridge.

In one embodiment, the nano-fiber membranes are prepared using an electrospinning method, wherein the nano-fiber membranes comprises tiny holes or pores for securely holding the porous adsorbents and the nano-porous adsorbents within the one or more columns of the cartridge, wherein the nano-fiber membranes are polymer nano-fiber membranes. In one embodiment, the ultrasonic source is an ultrasonic irradiation source, wherein the ultrasonic source is further configured to control the adsorption and the desorption of the metal ions, the organic compounds, and the inorganic compounds within the analyte solution.

In one embodiment, the system further comprises a control system in operatively communication with the system for controlling the adsorption and the desorption of the organic compounds and the inorganic compounds within the analyte solution. In one embodiment, the system further comprises a temperature control system with a heater, securely and operatively connected to the container for controlling the temperature of the analyte solution, thereby achieving adjustable temperature conditions for effectively adsorption and absorption of the metal ions, the organic compounds, and the absorbed compounds presented within the analyte solution. In one embodiment, the pump is configured to continuously circulate the analyte solution within the system via the circulating line, thereby increasing the performance of the adsorbent material according to time and flow rate of the analyte solution, wherein the flow rate of the analyte solution is controlled via the control system.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 illustrates a block diagram of a system for treating chemical byproducts within an analyte solution according to an embodiment of the present invention;

FIG. 2 illustrates a flowchart of a method for treating chemical byproducts within an analyte solution using the system according to one embodiment of the present invention.

### DETAILED DESCRIPTION

The present invention generally relates to a system and method for treating chemical byproducts within an analyte solution and more particularly relates to a system and method for treating chemical byproducts within the analyte solution using ultrasonic irradiation in different environmental conditions.

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

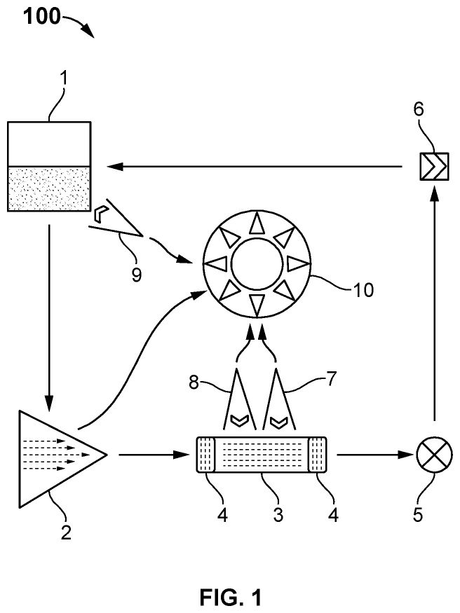

Referring to FIG. 1, a system 100 for treating chemical byproducts within an analyte solution is disclosed. In one embodiment, the system 100 used for treating chemical byproducts such as, but not limited to, metal ions, organic compounds, and inorganic compounds or any other chemical byproducts within the analyte. In one embodiment, the system 100 comprises a container 1, a cartridge 3 with one or more columns 4, a light source 7, an ultrasonic source 8, and a control system 10. In one embodiment, the container 1 is used for storing different analyte solutions. In one embodiment, the cartridge 3 and the columns 4 are fluidly connected to the container 1 via a circulating line using a pump 2. The cartridge 3 includes adsorbent materials and absorbent materials to adsorb and absorb the metal ions, the organic compounds, and the absorbed compounds presented within the analyte solution. In one embodiment, the columns 4 could be, but not limited to, interchangeable columns.

In one embodiment, the columns 4 of the cartridge 3 are very similar to a liquid chromatography column. In one embodiment, the columns 4 comprise at least any one of or a combination of, but not limited to, absorbents, porous adsorbents, and nano-porous adsorbents to adsorb and absorb the organic compounds and the inorganic compounds within the analyte solution. In one embodiment, the porous adsorbents and the nano-porous adsorbents are at least any one of or a combination of, but not limited to, porous silica adsorbents, nano-porous polymer membranes, and porous and nano-porous compounds to adsorb the organic compounds and the inorganic compounds within the analyte solution. In one embodiment, the nano-porous adsorbents/filters are interchangeable nano-porous membranes. In one embodiment, the columns 4 of the cartridge 3 further comprises nano-fiber membranes.

The nano-fiber membranes are configured to securely hold the porous adsorbents and the nano-porous adsorbents within the columns 4 of the cartridge 3. In one embodiment, the nano-fiber membranes are prepared using, but not limited to, an electrospinning method. In one embodiment, the nano-fiber membranes could be, but not limited to, polymer nano-fiber membranes. The nano-fiber membranes comprise tiny holes or pores for securely holding the porous adsorbents and the nano-porous adsorbents within the one or more columns of the cartridge. The analyte solution could easily pass from inside the pores of the nano-porous membranes/shields. In one embodiment, the quantity and type of the absorbents, the porous adsorbents, and the nano-porous adsorbents could be changed according to the type of the analyte solution.

In one embodiment, the light source 7 of the system 100 is configured to transmit light signals into the cartridge 3 and the columns 4 for increasing the activity and rate of adsorption, thereby effectively removing, extracting, and pre-concentration of the metal ions, the organic compounds, and the inorganic compounds within the analyte solution. In one embodiment, the light source 7 could be, but not limited to, visible ultraviolet light. The light source 7 is used as a light-sensitive adsorbent level activator for effectively improving the rate of the adsorption. In one embodiment, the ultrasonic source 8 is configured to send ultrasound waves into the cartridge 3 and the columns 4 for separating and desorption the metal ions, the organic compounds, and the absorbed compounds within the analyte solution.

The crashing of the ultrasound waves within the cartridge 3 and the columns 4 and circulation of the analyte solution could accelerate the desorption process. In one embodiment, the ultrasonic source 8 could be at least any one of, but not limited to, an ultrasonic irradiation source, an ultrasonic transducer, an ultrasonic bath, and an ultrasonic sensor. The ultrasonic source 8 could significantly decrease the absorption time. In one embodiment, the ultrasonic source 8 of the system 100 further configured to the adsorption and the desorption of the metal ions, the organic compounds, and the inorganic compounds within the analyte solution.

In one embodiment, the system 100 further comprises a control system 10. The control system 10 in operatively communication with the system 100 for controlling the adsorption and the desorption of the organic compounds and inorganic compounds within the analyte solution. In one embodiment, the control system 10 is further configured to effectively control the flow rate of the analyte solution by controlling the operation of the pump 2. The flow rate and pressure of the circulation of the analyte solution are easily adjustable.

The pump 2 could increase the performance of the absorbents within the cartridge 3 and the columns 4. In one embodiment, the system 100 further comprises a temperature control system with a heater 9. In one embodiment, the heater 9 is securely and operatively connected to the container 1 for controlling the temperature of the analyte solution, thereby achieving adjustable temperature conditions for effectively adsorption and absorption of the metal ions, the organic compounds, and the absorbed compounds presented within the analyte solution. In some embodiments, the system 100 could be used for removing chemical compounds from, but not limited to, gases and liquids.

In one embodiment, a valve 5 is connected within the circulating line for controlling the flow of the analyte solution. The valve 5 is configured to allow and stop the flow of the analyte solution within the circulating line. In one embodiment, a sampler 6 could be fluidly connected to the circulating line for analyzing the sample of the analyte solution. In some embodiments, the columns 4 with different sizes could be used are could be provided with a certain quantity of sorbents. In one embodiment, the system 100 further comprises a water circulation system around the container 1 for adjusting various temperatures. In one embodiment, the parts and components of the system 100 include, but not limited to, a container 1, a pumps 2, a cartridge 3 with one or more columns 4, a light source 7, an ultrasonic source 8, and a control system 10, could be easily controlled using embedded keys of each part and component. In one embodiment, parts and components of the system 100 are replaceable, efficient, and require minimum space for installation and less maintenance.

The system 100 could be produced and used in large scale due to the use of inexpensive and simple components and electronic systems in construction. In one embodiment, the system 100 could require a power supply and works on alternating current (AC). The volume and amount of the adsorbents used in the system 100 could be manageable with replacement components.

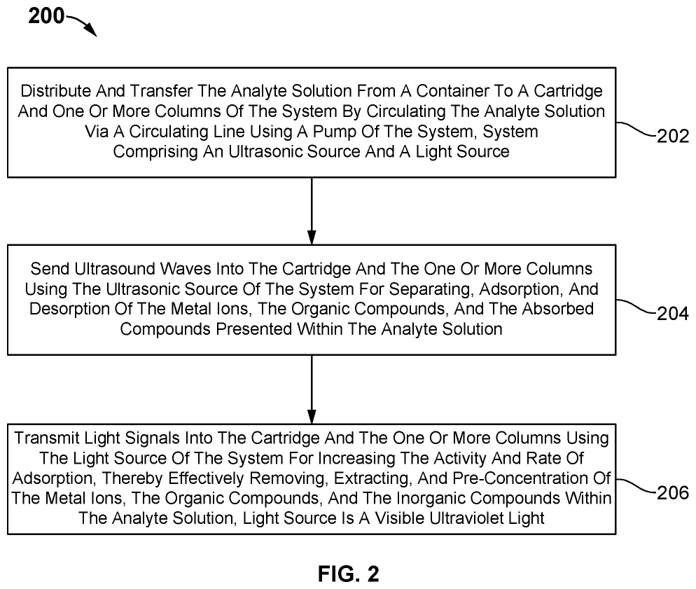

Referring to FIG. 2, a flowchart for a method 200 for treating chemical byproducts using the system 100 (shown in FIG. 1) is disclosed. The chemical byproducts such as, but not limited to, metal ions, organic compounds, and inorganic compounds. The method 200 used for removal, extract, and pre-concentration, of metal ions, organic compounds, and inorganic compounds or any chemical byproducts within an analyte solution. In one embodiment, the method 200 is based on a solid phase extraction technique. At one step 202, the analyte solution is distributed and transferred from the container 1 (shown in FIG. 1) to the cartridge 3 (shown in FIG. 1) and the columns 4 (shown in FIG. 1) by circulating the analyte solution via a circulating line using a pump 2 (shown in FIG. 1) of the system 100.

The cartridge 3 and the columns 4 includes adsorbent materials and absorbent materials to adsorb and absorb the metal ions, the organic compounds, and the absorbed compounds presented within the analyte solution. At step 204, the ultrasound waves are sent into the cartridge 3 and the columns 4 using the ultrasonic source 8 (shown in FIG. 1) of the system 100 for separating, adsorption, and desorption of the metal ions, the organic compounds, and the absorbed compounds presented within the analyte solution. Further, at step 206, the light signals are transmitted into the cartridge 3 and the columns 4 using the light source 7 (shown in FIG. 1) for increasing the activity and rate of adsorption, thereby effectively removing, extracting, and pre-concentration of the metal ions, the organic compounds, and the inorganic compounds within the analyte solution. In one embodiment, the light source 7 could be, but not limited to, visible ultraviolet (UV) light.

In one embodiment, the system 100 could be used for removing contaminants in by-products of factories. In one embodiment, the system 100 could be used for pre-concentration of metal ions in the various real water sample for determination. In some embodiments, the system 100 could be used for, but not limited to, water treatment in food production factories, extraction of valuable chemical compounds in the several fields, and determination of trace chemical compounds in the various laboratories.

The advantages of the present invention include: the system 100 is configured to control adsorption and desorption of the metal ions, the organic compounds, and the inorganic compounds presented within the analyte solution. The quantity and type of the absorbents, the porous adsorbents, and the nano-porous adsorbents could be changed according to the type of the analyte solution. The nano-fiber membranes within the columns 4 of the cartridge 3 could hold the porous adsorbents and the nano-porous adsorbents within the cartridge 3 and the columns 4.

The system 100 could control the ambient temperature using the temperature control system with the heater 9. The continuous circulation of the analyte solution using the pump 2 increases the absorption and desorption efficiency. The nano-porous adsorbents/filters within the columns 4 of the cartridge 3 are used for preservation of nano-porous compounds within the analyte solution. The columns 4 of the cartridge 3 are interchangeable columns. The columns 4 are designed with different sizes and ability to maintain adsorbents with nano-porous adsorbents/filters. The nano-porous adsorbents/filters are interchangeable nano-porous membranes.

The nano-porous adsorbents/filters increase efficiency and solve the problem of maintenance of absorbents in the prior/conventional systems. Also, nano-porous adsorbents/filters could be cheaply provided by the electro-spinning method. The absorbents within the cartridge 3 and the columns 4 are reuseful and low consumption of chemical reagents. The circulation of the analyte solution increases the system performance compared to prior systems such as, but not limited to, batch system or conventional absorber columns.

The ultrasonic source 8 is a simple and inexpensive technique for separation with very high efficiency and significantly increases desorption efficiency. The temperature of the analyte solution could be easily controlled by using a chiller. The light source 7 could increase the efficiency of the absorption by activating light-sensitive absorbent surfaces. The system 100 could be used to prepare the samples for determination. The adsorption and desorption efficiency of the analyte solution could be simply controlled by the power of ultrasound and light intensity. The system 100 could be efficiently used in different environmental conditions, low cost, simple operation, easy automation, and environmentally friendly.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions.

Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. A system for treating chemical byproducts within an analyte solution, comprising:
a container for storing the analyte solution;
a cartridge with one or more columns, fluidly connected to the container via a circulating line using a pump, wherein the cartridge having adsorbent materials and absorbent materials to adsorb and absorb the metal ions, the organic compounds, and the absorbed compounds presented within the analyte solution;
an ultrasonic source configured to send ultrasound waves into the cartridge and the one or more columns for separating and desorption the metal ions, the organic compounds, and the absorbed compounds presented within the analyte solution, and
a light source configured to transmit light signals into the cartridge and the one or more columns for increasing the activity and rate of adsorption, thereby effectively removing, extracting, and pre-concentration of the metal ions, the organic compounds, and the inorganic compounds within the analyte solution.

2. The system of claim 1, wherein the one or more columns comprise at least any one of or a combination of absorbents, porous adsorbents, and nano-porous adsorbents for adsorption and absorption of the organic compounds and the inorganic compounds within the analyte solution, wherein the one or more columns are interchangeable columns.

3. The system of claim 2, wherein the porous adsorbents and the nano-porous adsorbents are at least any one of or a combination of porous silica adsorbents, nano-porous polymer membranes, and porous and nano-porous compounds to adsorb the organic compounds and the inorganic compounds within the analyte solution.

4. The system of claim 1, wherein the one or more columns of the cartridge further comprises nano-fiber membranes, wherein the nano-fiber membranes are configured to securely hold the porous adsorbents and the nano-porous adsorbents within the one or more columns of the cartridge.

5. The system of claim 4, wherein the nano-fiber membranes comprises tiny holes or pores for securely holding the porous adsorbents and the nano-porous adsorbents within the one or more columns of the cartridge.

6. The system of claim 4, wherein the nano-fiber membranes are prepared using an electrospinning method, wherein the nano-fiber membranes are polymer nano-fiber membranes.

7. The system of claim 1, wherein the ultrasonic source is an ultrasonic irradiation source, wherein the ultrasonic source is further configured to control the adsorption and the desorption of the metal ions, the organic compounds, and the inorganic compounds within the analyte solution.

8. The system of claim 1, further comprises a control system in operatively communication with the system for controlling the adsorption and the desorption of the organic compounds and the inorganic compounds within the analyte solution.

9. The system of claim 1, further comprises a temperature control system with a heater, securely and operatively connected to the container for controlling the temperature of the analyte solution, thereby achieving adjustable temperature conditions for effectively adsorption and absorption of the metal ions, the organic compounds, and the absorbed compounds presented within the analyte solution.

10. The system of claim 1, wherein the light source is a visible ultraviolet light, wherein the light source is used as a light-sensitive adsorbent level activator for effectively improving the rate of the adsorption.

11. The system of claim 1, wherein the pump is configured to continuously circulate the analyte solution within the system via the circulating line, thereby increasing the performance of the adsorbent material according to time and flow rate of the analyte solution, wherein the flow rate of the analyte solution is controlled via the control system.

12. A method for treating chemical byproducts within an analyte solution using a system, comprising the steps of:
distributing and transferring the analyte solution from a container to a cartridge and one or more columns of the system by circulating the analyte solution via a circulating line using a pump of the system, system comprising a container, a cartridge with one or more columns, an ultrasonic source, and a light source;
sending ultrasound waves into the cartridge and the one or more columns using the ultrasonic source of the system for separating, adsorption, and desorption of the metal ions, the organic compounds, and the absorbed compounds presented within the analyte solution, and
transmitting light signals into the cartridge and the one or more columns using the light source of the system for increasing the activity and rate of adsorption, thereby effectively removing, extracting, and pre-concentration of the metal ions, the organic compounds, and the inorganic compounds within the analyte solution, light source is a visible ultraviolet light.

13. The method of claim 12, wherein the one or more columns comprise at least any one of or a combination of absorbents, porous adsorbents, and nano-porous adsorbents for adsorption and absorption of the organic compounds and the inorganic compounds within the analyte solution, wherein the one or more columns are interchangeable columns.

14. The method of claim 13, wherein the porous adsorbents and the nano-porous adsorbents are at least any one of or a combination of porous silica adsorbents, nano-porous polymer membranes, porous compounds, and nano-porous compounds to adsorb the organic compounds and the inorganic compounds within the analyte solution.

15. The method of claim 12, wherein the one or more columns of the cartridge further comprises nano-fiber membranes, wherein the nano-fiber membranes are configured to securely hold the porous adsorbents and the nano-porous adsorbents within the one or more columns of the cartridge.

16. The method of claim 15, wherein the nano-fiber membranes are prepared using an electrospinning method, wherein the nano-fiber membranes comprises tiny holes or pores for securely holding the porous adsorbents and the nano-porous adsorbents within the one or more columns of the cartridge, wherein the nano-fiber membranes are polymer nano-fiber membranes.

17. The method of claim 12, wherein the ultrasonic source is an ultrasonic irradiation source, wherein the ultrasonic source is further configured to control the adsorption and the desorption of the metal ions, the organic compounds, and the inorganic compounds within the analyte solution.

18. The method of claim 12, wherein the system further comprises a control system in operatively communication with the system for controlling the adsorption and the desorption of the organic compounds and the inorganic compounds within the analyte solution.

19. The method of claim 12, wherein the system further comprises a temperature control system with a heater, securely and operatively connected to the container for controlling the temperature of the analyte solution, thereby achieving adjustable temperature conditions for effectively adsorption and absorption of the metal ions, the organic compounds, and the absorbed compounds presented within the analyte solution.

20. The method of claim 12, wherein the pump is configured to continuously circulate the analyte solution within the system via the circulating line, thereby increasing the performance of the adsorbent material according to time and flow rate of the analyte solution, wherein the flow rate of the analyte solution is controlled via the control system.
